(19) United States
(12) Patent Application Publication
(10) Pub. No.: US 2026/0241828 A1
(43) Pub. Date: Aug. 20, 2026

(54) SYSTEM AND METHOD FOR AUTHENTICATING ELECTRIC VEHICLES USING HARDWARE-BASED IDENTIFIERS

(71) Applicant: Micron Technology, Inc., Boise, ID (US)

(72) Inventors: Francesco Lupo, Munich (DE); Sebastiano Pischedda, Novi, MI (US); Stefano Corno, Munich (DE)

(21) Appl. No.: 19/437,168

(22) Filed: Dec. 30, 2025

Related U.S. Application Data
(60) Provisional application No. 63/760,948, filed on Feb. 20, 2025.

(51) Int. Cl. B60L 53/65; B60L 53/62; B60L 53/68; H04L 9/40

(52) U.S. Cl. CPC B60L 53/65; B60L 53/62; B60L 53/68; H04L 63/0876

(57) ABSTRACT

A charging station may receive a connection request from an electric vehicle. A charging station may request a unique identifier from a NOR flash memory device in the electric vehicle. A charging station may receive the unique identifier from the electric vehicle. A charging station may transmit the unique identifier to a cloud service. A charging station may receive an authorization response from the cloud service based on a verification of the unique identifier against a denylist database. A charging station may selectively enable or disable charging power to the electric vehicle based on the authorization response.

### RELATED APPLICATIONS

The present application claims priority to Prov. U.S. patent application Ser. No. 63/760,948 filed Feb. 20, 2025, the entire disclosures of which application are hereby incorporated herein by reference.

### BACKGROUND

Electric vehicles (EVs) have gained significant market share in the automotive industry, driven by environmental concerns and technological advancements. As the EV market grows, charging infrastructure has expanded to include numerous public charging stations accessible to any compatible vehicle. These charging stations provide both power delivery and data communication capabilities to support modern charging protocols.

Public charging stations typically require some form of authentication or payment verification before providing charging services. Common authentication methods include radio frequency identifier (RFID) cards, mobile applications, or credit card payments at the charging terminal. These authentication methods primarily focus on payment processing rather than vehicle security.

Vehicle identification has traditionally relied on physical markings such as Vehicle Identification Numbers (VINs) in the United States stamped into the chassis or license plates mounted on the exterior. While these identifiers serve important purposes for vehicle registration and tracking, they are primarily physical in nature and designed for visual inspection rather than digital authentication.

NOR flash memory devices are commonly used in automotive applications due to their reliability and fast read performance. These memory devices store firmware and configuration data needed for vehicle operation. Like many electronic components, NOR flash devices include various standard features to support system integration and manufacturing processes.

### BRIEF DESCRIPTION OF THE DRAWINGS

FIG. 1 is a block diagram illustrating a system for authenticating electric vehicles using memory-based identifiers according to some embodiments.

FIG. 2 is a sequence diagram illustrating a method for authenticating an electric vehicle during a charging operation according to some embodiments.

FIG. 3 is a flow diagram illustrating a method for reading and validating a unique identifier (UID) from NOR flash memory according to some embodiments.

FIG. 4 is a flow diagram illustrating a method for verifying a vehicle's authorization status using its unique identifier (UID) according to some embodiments.

FIG. 5 is a flow diagram illustrating a method for registering and associating a NOR memory UID with a vehicle during the manufacturing process according to some embodiments.

FIG. 6 is a block diagram of a computing device according to some embodiments of the disclosure.

### DETAILED DESCRIPTION

In some implementations, the techniques described herein relate to a method including: receiving, by a charging station, a connection request from an electric vehicle; requesting, by the charging station, a unique identifier from a NOR flash memory device in the electric vehicle; receiving, by the charging station, the unique identifier from the electric vehicle; transmitting, by the charging station, the unique identifier to a cloud service; receiving, by the charging station, an authorization response from the cloud service based on a verification of the unique identifier against a denylist database; and selectively enabling or disabling, by the charging station, charging power to the electric vehicle based on the authorization response.

In some implementations, the techniques described herein relate to a method, wherein requesting the unique identifier includes sending a READ ID command to the NOR flash memory device to retrieve a device identification data structure.

In some implementations, the techniques described herein relate to a method, wherein receiving the unique identifier includes: receiving a 20-byte device identification data structure; and extracting a 14-byte unique identifier from the device identification data structure.

In some implementations, the techniques described herein relate to a method, wherein transmitting the unique identifier includes: formatting the unique identifier according to a charging protocol; and transmitting the unique identifier and contextual data to the cloud service, the contextual data including one or more of a charging station identifier and location.

In some implementations, the techniques described herein relate to a method, wherein receiving the authorization response includes: receiving a signed authorization token when the unique identifier is not found in the denylist database; and receiving a denial message and alerting authorities when the unique identifier is found in the denylist database.

In some implementations, the techniques described herein relate to a method, further including: caching, by the charging station, the authorization response for a time period; and using, by the charging station, the authorization response to authorize charging requests during the time period when a network connection to the cloud service is not available.

In some implementations, the techniques described herein relate to a method, further including: monitoring, by the charging station, power delivery parameters during charging; periodically, by the charging station, validating the authorization response remains valid; and terminating, by the charging station, power delivery if the authorization response becomes invalid during charging.

In some implementations, the techniques described herein relate to a non-transitory computer-readable storage medium for tangibly storing computer program instructions capable of being executed by a computer processor, the computer program instructions defining steps of: receiving, by a charging station, a connection request from an electric vehicle; requesting, by the charging station, a unique identifier from a NOR flash memory device in the electric vehicle; receiving, by the charging station, the unique identifier from the electric vehicle; transmitting, by the charging station, the unique identifier to a cloud service; receiving, by the charging station, an authorization response from the cloud service based on a verification of the unique identifier against a denylist database; and selectively enabling or disabling, by the charging station, charging power to the electric vehicle based on the authorization response.

In some implementations, the techniques described herein relate to a non-transitory computer-readable storage medium, wherein requesting the unique identifier includes sending a READ ID command to the NOR flash memory device to retrieve a device identification data structure.

In some implementations, the techniques described herein relate to a non-transitory computer-readable storage medium, wherein transmitting the unique identifier includes: formatting the unique identifier according to a charging protocol; and transmitting the unique identifier and contextual data to the cloud service, the contextual data including one or more of a charging station identifier and location.

In some implementations, the techniques described herein relate to a non-transitory computer-readable storage medium, wherein receiving the authorization response includes: receiving a signed authorization token when the unique identifier is not found in the denylist database; and receiving a denial message and alerting authorities when the unique identifier is found in the denylist database.

In some implementations, the techniques described herein relate to a non-transitory computer-readable storage medium, the steps further including: caching, by the charging station, the authorization response for a time period; and using, by the charging station, the authorization response to authorize charging requests during the time period when a network connection to the cloud service is not available.

In some implementations, the techniques described herein relate to a non-transitory computer-readable storage medium, the steps further including: monitoring, by the charging station, power delivery parameters during charging; periodically, by the charging station, validating the authorization response remains valid; and terminating, by the charging station, power delivery if the authorization response becomes invalid during

### Charging.

In some implementations, the techniques described herein relate to a device including: a processor; and a storage medium for tangibly storing thereon program logic for execution by the processor, the program logic including steps for: receiving a connection request from an electric vehicle; requesting a unique identifier from a NOR flash memory device in the electric vehicle; receiving the unique identifier from the electric vehicle; transmitting the unique identifier to a cloud service; receiving an authorization response from the cloud service based on a verification of the unique identifier against a denylist database; and selectively enabling or disabling charging power to the electric vehicle based on the authorization response.

In some implementations, the techniques described herein relate to a device, wherein requesting the unique identifier includes sending a READ ID command to the NOR flash memory device to retrieve a device identification data structure.

In some implementations, the techniques described herein relate to a device, wherein receiving the unique identifier includes: receiving a 20-byte device identification data structure; and extracting a 14-byte unique identifier from the device identification data structure.

In some implementations, the techniques described herein relate to a device, wherein transmitting the unique identifier includes: formatting the unique identifier according to a charging protocol; and transmitting the unique identifier and contextual data to the cloud service, the contextual data including one or more of a charging station identifier and location.

In some implementations, the techniques described herein relate to a device, wherein receiving the authorization response includes: receiving a signed authorization token when the unique identifier is not found in the denylist database; and receiving a denial message and alerting authorities when the unique identifier is found in the denylist database.

In some implementations, the techniques described herein relate to a device, the steps further including: caching the authorization response for a time period; and using the authorization response to authorize charging requests during the time period when a network connection to the cloud service is not available.

In some implementations, the techniques described herein relate to a device, the steps further including: monitoring power delivery parameters during charging; periodically validating the authorization response remains valid; and terminating power delivery if the authorization response becomes invalid during charging.

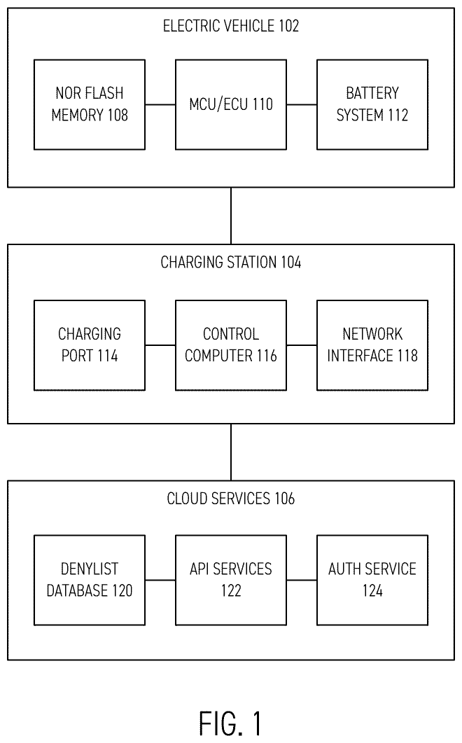

FIG. 1 is a block diagram illustrating a system for authenticating electric vehicles using memory-based identifiers according to some embodiments.

In the illustrated system, an electric vehicle 102 is communicatively coupled to a charging station 104, which in turn communicates with cloud services 106.

Electric vehicle 102 includes several components to enable secure authentication. In some implementations, a NOR memory 108 stores a unique identifier (UID) that is permanently programmed during manufacturing. The UID serves as an immutable identifier for the vehicle. A vehicle MCU/ECU 110 is communicatively coupled to NOR memory 108 and can read the UID using standard memory access commands. The MCU/ECU 110 controls a battery system 112 which receives charging power when authorized.

Charging station 104 includes a charging port 114 that provides both power delivery and data connectivity to EVs. The charging port 114 is coupled to a control computer 116 which manages charging operations and authentication procedures. Control computer 116 communicates through a network interface 118 to exchange authentication data with remote services.

Cloud services 106 provide centralized authentication capabilities through multiple coordinated components. A denylist database 120 maintains records of UIDs associated with stolen or unauthorized vehicles. API services 122 provide secure interfaces for querying the denylist database and processing authentication requests. An authorization service 124 makes final determinations on whether to permit charging based on UID verification results.

During operation, when electric vehicle 102 connects to charging station 104 through charging port 114, a power and data connection is established. The control computer 116 of the charging station 104 initiates an authentication sequence by requesting the UID from the NOR memory 108 of a vehicle through MCU/ECU 110. Upon receiving the UID, control computer 116 transmits a UID verification request through network interface 118 to cloud services 106.

Within cloud services 106, the API services 122 receive the verification request and query denylist database 120 to determine if the UID is associated with an unauthorized vehicle. The authorization service 124 processes the database response and generates an appropriate authorization decision. This decision is then transmitted back to charging station 104 as an authorization response.

If the authorization response indicates the UID is valid (i.e., not denylisted), charging station 104 enables power delivery through charging port 114 to battery system 112. However, if the UID is found in denylist database 120, the authorization response will deny charging privileges and charging station 104 will prevent power delivery to the vehicle.

The system's architecture ensures secure authentication through several features. First, the UID stored in NOR memory 108 cannot be modified or tampered with as it can be programmed in a one-time programmable memory area during manufacturing. Second, the control computer 116 of the charging station 104 must receive positive authentication before enabling power delivery, preventing unauthorized access to charging resources. Finally, the cloud-based authentication services provide a centralized, continuously updated database of unauthorized UIDs that can be quickly queried during the charging process.

This system architecture can provide real-time authentication of electric vehicles while leveraging existing charging infrastructure. The integration of hardware-based identifiers with networked charging stations provides a robust method for preventing unauthorized vehicles from accessing charging services. Additionally, the cloud-based services enable rapid updates to the denylist database, ensuring the system can quickly respond to newly reported unauthorized vehicles.

The system can be extended to support additional features beyond basic authentication. For example, authorization service 124 could implement graduated access levels, allowing certain UIDs to receive limited charging capabilities rather than complete denial of service. The system could also integrate with law enforcement systems to automatically notify authorities when denylisted vehicles attempt to charge.

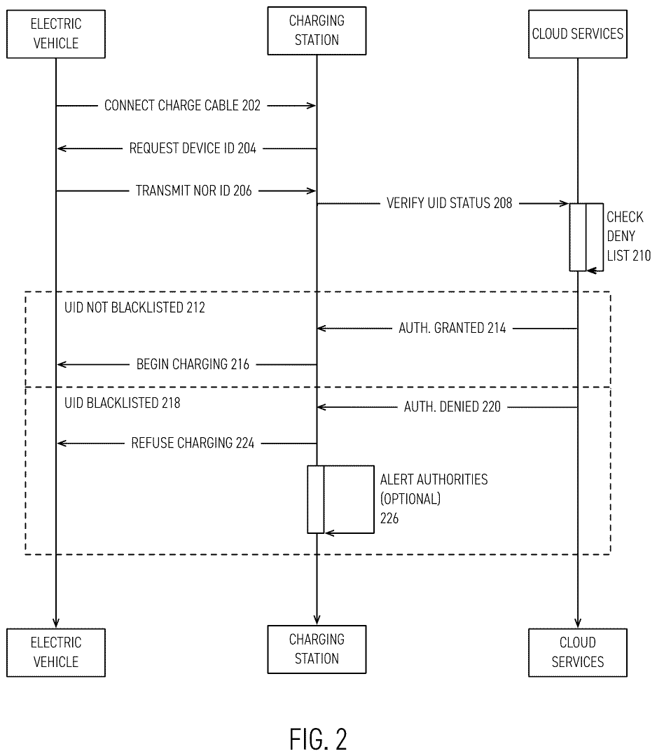

FIG. 2 is a sequence diagram illustrating a method for authenticating an electric vehicle during a charging operation according to some embodiments. The sequence illustrates the complete authentication flow that occurs whenever an electric vehicle attempts to initiate a charging session at a public charging station.

The sequence diagram illustrates interactions between three primary participants: an electric vehicle (“EV”), a charging station (“CS”), and a cloud service (“Cloud”). Each participant represents a system of interconnected components that work together to ensure secure and reliable charging authorization. The EV includes NOR flash memory containing the UID, an MCU/ECU for control operations, and a battery management system. The charging station comprises power delivery hardware, control computers, and network interfaces. The cloud service encompasses database systems, API services, and authorization logic.

In step 202, the sequence begins when the EV connects a charging cable to the charging station. This physical connection establishes both power delivery capabilities and a data communication channel between the EV and charging station. The data connection may use the Control Pilot (CP) and Proximity Pilot (PP) pins in the charging connector to establish initial communication. In some implementations, the data communication channel may utilize standard charging protocols such as ISO 15118 or CHAdeMO that support bidirectional communication. These protocols provide standardized message formats and sequences for negotiating charging parameters and exchanging authentication data.

In step 204, upon detecting the physical connection, the charging station initiates the authentication sequence by sending a device identification request to the EV. This request prompts the EV to provide its unique identifier for verification. The request typically includes a protocol version identifier and supported authentication methods. In some implementations, the request may include a challenge-response mechanism to ensure the authenticity of the communication channel. The challenge could include a random nonce or timestamp to prevent replay attacks. The charging station may also include its own identifier and capabilities in this request to support mutual authentication.

In step 206, the EV responds by transmitting its NOR UID to the charging station. This step involves several internal operations within the EV. First, the EV's MCU/ECU executes a READ ID operation on the NOR flash memory to retrieve the 14-byte UID. This operation utilizes standardized memory access commands that are commonly implemented across NOR flash devices. The READ ID operation is an unsigned command that typically completes in less than one microsecond. The UID itself is composed of manufacturing data such as the diffusion lot number, wafer number, die coordinates, production timestamp, and random numbers that ensure uniqueness. Once retrieved, the UID is formatted according to the charging protocol's specifications and transmitted to the charging station through the established data channel. In some implementations, this transmission may be encrypted using session keys established during the initial handshake.

In step 208, the charging station forwards the received UID to the cloud service for verification. This step initiates the authentication process by requesting the cloud service to verify the UID's status. The verification request typically includes contextual information such as: the charging station's unique identifier, geographic location, timestamp, session identifier, charging capabilities (power levels, supported protocols), and optionally the vehicle's detected battery status. This additional information helps prevent fraud and enables detailed audit trails. In some implementations, the charging station may cache recent authorization results to handle temporary network outages, though cached results would have limited validity periods.

In step 210, the cloud service performs an internal check of its denylist database. This critical step involves querying a distributed database system that maintains records of unauthorized UIDs. The database is continuously updated with information from various sources including law enforcement agencies, vehicle manufacturers, and charging network operators. Each database record may include: the denylisted UID, reason for denylisting, timestamp of denylisting, geographic scope of the denylisting, and any special handling instructions. The database query may employ matching algorithms to handle partial UIDs or pattern-based denylisting. In some implementations, the database may also maintain allowlists for known-good UIDs or special access permissions.

Following the database check, the sequence diverges based on the UID's status. In step 212, the system determines whether the UID is denylisted, leading to two possible paths of execution. This decision point may incorporate multiple factors beyond simple denylist status, such as regional restrictions, time-of-day permissions, or graduated access levels.

If the UID is not found in the denylist database, the authorization path begins at step 214, where the cloud service sends an authorization granted message to the charging station. This message indicates that the EV is cleared to receive charging services. The authorization message typically includes: a digital signature to prevent tampering, an authorization token for the charging session, permitted charging parameters (maximum power, duration, energy), pricing information, and an expiration timestamp. In some implementations, the authorization may include specific constraints or monitoring requirements based on the vehicle's history or status.

Following successful authorization, in step 216, the charging station initiates the charging process by enabling power delivery to the EV. This step involves configuring the charging port's power delivery parameters according to the EV's capabilities and any limitations specified in the authorization message. The charging station maintains continuous monitoring of the power delivery and periodically validates the authorization token's status. The station may also collect detailed charging metrics for billing and analysis purposes.

Alternatively, if the UID is found in the denylist database, the sequence follows the denial path beginning at step 218. This path implements secure handling of unauthorized charging attempts while potentially gathering intelligence about stolen or compromised vehicles. In step 220, the cloud service sends an authorization denied message to the charging station. This message includes the denial reason code and any special handling instructions. The denial message is digitally signed to prevent tampering and may trigger automated alerts to relevant stakeholders.

Upon receiving the denial message, in step 224, the charging station refuses to initiate charging operations and communicates this denial to the EV. The charging station ensures all power delivery circuits remain disabled and logs the denial event. In some implementations, this communication may include the reason for denial, allowing the EV to display appropriate information to the user. The station may implement progressive delays or temporary lockouts for repeated unauthorized attempts.

Optionally, in step 226, the charging station may alert relevant authorities about the attempted charging operation by a denylisted vehicle. This notification can include comprehensive details such as: the UID, timestamp, location coordinates, charging station identifier, any vehicle information collected during the session, and optionally image captures from station cameras if equipped. The alert may be routed through the cloud service to appropriate law enforcement channels, enabling real-time tracking of unauthorized vehicles. Some implementations may activate nearby charging stations to create a monitoring network for tracking vehicle movement patterns.

The sequence diagram illustrates several aspects of the authentication system. First, it demonstrates how the system leverages existing charging infrastructure by utilizing the data communication capabilities of modern charging connections. Second, it shows how the hardware-based UID serves as a secure identifier throughout the authentication process, providing a level of security similar to mobile device IMEI codes. Third, it illustrates the real-time nature of the verification process, allowing for immediate response to attempted charging by unauthorized vehicles while maintaining normal charging operations for authorized vehicles.

In some implementations, the sequence may include additional security measures to enhance the robustness of the authentication process. The UID transmission in step 206 may employ multiple encryption layers: a session-specific encryption for the communication channel and an additional layer of encryption for the UID itself. The charging station may implement timeout mechanisms that balance security with user experience-for example, allowing longer timeouts during peak network congestion periods while maintaining stricter timeouts during normal operations. The system supports multiple retry attempts with exponential backoff periods to handle temporary communication failures with the cloud service, but implements strict limits on the number of retries to prevent abuse.

The sequence may also implement various fallback mechanisms for exceptional scenarios. For example, in regions with unreliable network connectivity, charging stations may maintain a locally cached copy of the denylist database that is periodically updated when connectivity is available. This cache would have a limited validity period and might only enable restricted charging capabilities. Similarly, in emergency situations, there may be override protocols that allow emergency service vehicles to charge regardless of their UID status, though such overrides would require special authentication credentials and would trigger immediate logging and notification.

In yet other implementations, the sequence may support graduated responses based on the reason for denylisting. Vehicles with outstanding payments might receive limited charging capabilities (e.g., enough charge to reach a service center) rather than complete denial. Vehicles subject to manufacturer recalls might receive normal charging capabilities but trigger notifications to the owner about required service. Stolen vehicles would be denied service entirely and trigger immediate authority notification. This granular control enables the system to implement nuanced policies while maintaining security.

The sequence also supports integration with vehicle manufacturer systems for enhanced functionality. Manufacturers can use the UID verification process to track warranty status, push software updates, or implement recall notifications. The charging session can serve as a trusted communication channel between the vehicle and manufacturer systems, enabling secure over-the-air updates and diagnostics.

Throughout the entire sequence, comprehensive logging and auditing mechanisms record each step of the process. These logs include timestamps, cryptographic proof of each message's authenticity, and detailed context information. The logging system provides accountability and enables forensic analysis of any security incidents while maintaining user privacy through appropriate data anonymization techniques.

The authentication sequence described in FIG. 2 thus provides a robust, scalable, and flexible framework for securing electric vehicle charging operations. By leveraging the immutable nature of NOR flash UIDs combined with real-time cloud-based verification, the system creates a highly secure yet user-friendly charging authentication mechanism that can adapt to various security requirements and operational scenarios.

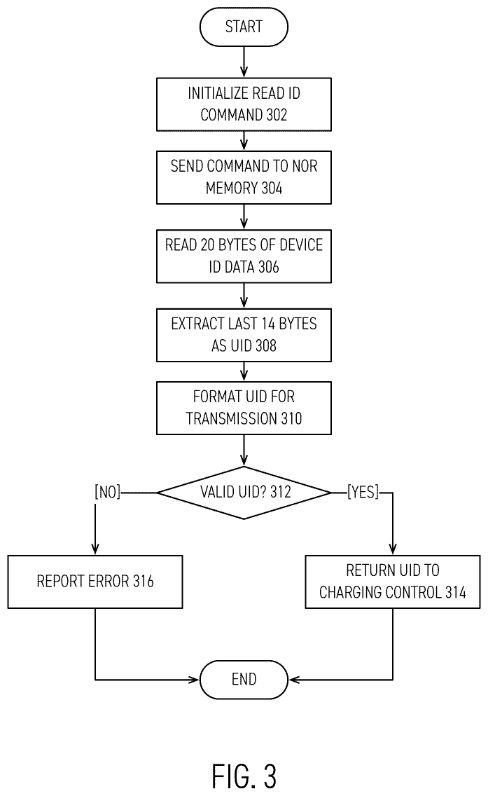

FIG. 3 is a flow diagram illustrating a method for reading and validating a unique identifier (UID) from NOR flash memory according to some embodiments. The method demonstrates the detailed process of retrieving the UID that serves as the foundation for the vehicle authentication system. This process executes within the vehicle's MCU/ECU system whenever UID verification is required for charging authentication.

In step 302, the method begins by initializing the READ ID command. This initialization involves preparing the standardized command sequence recognized by NOR flash memory devices. The READ ID operation is an unsigned command supported across different NOR memory manufacturers, ensuring broad compatibility. The command initialization includes setting up the appropriate op-code (e.g., 0x9F for READ ID operations), preparing the memory bus for the operation, and configuring any necessary timing parameters. The initialization process also includes setting up the proper chip select signals if multiple memory devices are present on the same bus.

In step 304, the initialized command is sent to the NOR memory device. The command transmission occurs over the memory bus interface, typically using standard SPI or Quad-SPI protocols. For SPI mode, this involves managing the serial clock (SCK), chip select (CS), data input (DI), and data output (DO) signals according to the memory device's specifications. In Quad-SPI mode, the command utilizes four data lines to achieve higher throughput. In some implementations, this step includes proper timing management to ensure reliable command transmission according to the memory device's specifications. The command is transmitted using the memory device's native command protocol, which may operate at frequencies up to several hundred megahertz.

In step 306, the method reads 20 bytes of Device ID data from the memory. This data is stored in a dedicated one-time programmable (OTP) array outside the main memory array, ensuring its immutability. The 20-byte sequence contains the complete device identification information, including: manufacturer ID (1 byte), memory type (1 byte), memory capacity (1 byte), remaining ID length (1 byte), extended device information (1 byte), device configuration (1 byte), and the unique identifier data (14 bytes). In some implementations, this read operation completes in less than one microsecond, making it highly efficient for real-time authentication scenarios. The read operation includes built-in error detection to ensure data integrity during transmission over the memory bus.

In step 308, the method extracts the last 14 bytes from the device ID data to obtain the UID. These bytes contain the customized factory data that ensures uniqueness across all manufactured devices. The UID comprises several elements: diffusion lot number (4 bytes), wafer number (1 byte), die X-Y coordinates (2 bytes each), production timestamp (3 bytes), and additional random values (2 bytes). This combination of manufacturing data and random elements ensures that no two devices share the same UID. The extraction process includes byte alignment checks to ensure proper data boundaries are maintained.

In step 310, the extracted UID is formatted for transmission according to the charging protocol's requirements. This formatting may include: byte ordering adjustments (e.g., converting between big-endian and little-endian representations), checksum calculation using CRC-32 or similar algorithms, addition of protocol-specific headers or footers, and preparation of any required metadata such as timestamp or sequence numbers. In some implementations, the formatting step may also include encryption of the UID data to protect it during transmission. The formatting ensures the UID data will be correctly interpreted by the charging station's control systems.

In step 312, the method validates the formatted UID to ensure its integrity. This validation step includes multiple checks: verifying the UID's length is exactly 14 bytes, confirming all bytes contain valid values within expected ranges, checking any internal consistency markers, validating checksums or error detection codes, and verifying that the manufacturer ID and device type fields match expected values. The validation also ensures that none of the bytes are stuck at fixed values (all 0s or all 1s), which could indicate a hardware failure. Some implementations may also verify that the production timestamp falls within a valid manufacturing date range.

If the validation succeeds, the method proceeds to step 314, where the validated UID is returned to the charging control system. The return value includes the formatted UID along with any required metadata or status information. This metadata may include the validation timestamp, number of retries required (if any), and memory device status information. The UID is then cached in volatile memory for potential reuse during the same charging session, reducing the need for repeated reads from the NOR device.

If the validation fails, the method proceeds to step 316, where it reports an appropriate error condition. The error report includes detailed information about the nature of the validation failure, such as invalid length, checksum mismatch, formatting error, or timing violations. The error data includes diagnostic information such as the raw Device ID data, specific validation checks that failed, and any relevant system state information. In some implementations, the error handling may include retry attempts for transient failures or logging of persistent errors for diagnostic purposes. Critical errors may trigger a system notification to the vehicle's diagnostic systems.

The method illustrated in FIG. 3 demonstrates several aspects of the UID retrieval process. First, it shows how the system leverages standard NOR memory commands to access the UID, ensuring compatibility across different memory devices. Second, it illustrates the multiple validation steps that ensure the integrity of the UID before it's used for authentication. Finally, it shows how the process is optimized for performance while maintaining reliability through comprehensive error checking and handling mechanisms.

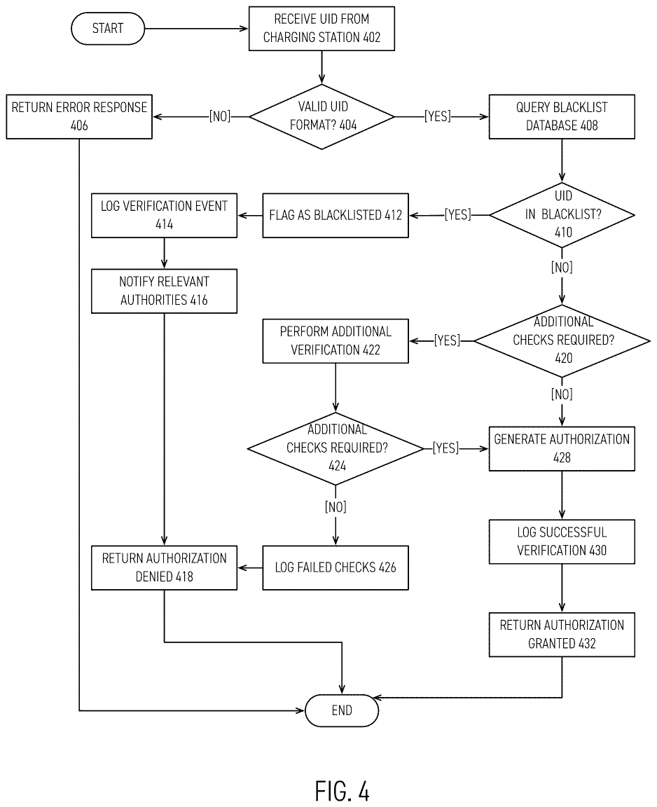

FIG. 4 is a flow diagram illustrating a method for verifying a vehicle's authorization status using its unique identifier (UID) according to some embodiments. The method executes within the cloud service infrastructure and implements the complete verification workflow from initial UID receipt through final authorization decision. This verification process is designed to provide fast, reliable authentication while maintaining security and supporting a variety of authorization policies.

In step 402, the method begins when the cloud service receives a UID from a charging station. The received data package typically includes the 14-byte UID along with contextual information such as: charging station identifier, timestamp, geographic location, session parameters, power level requirements, and initial battery state information. This data arrives through secure API endpoints that implement TLS 1.3 encryption and client certificate authentication. The endpoints are load-balanced across multiple regions to ensure high availability and low latency responses.

In step 404, the method validates the format of the received UID. This validation includes verifying the UID length is exactly 14 bytes, checking byte patterns match expected manufacturing formats, validating checksums, and ensuring all required contextual data is present and properly formatted. The validation process also checks that the charging station's credentials are current, that the request follows API rate limiting policies, and that the timestamp is within acceptable synchronization limits. The method implements error detection to identify potential tampering or data corruption during transmission.

If the validation fails, the method proceeds to step 406, where it generates and returns an error response to the charging station. The error response includes specific error codes mapped to each validation check, detailed diagnostic information about the failure, and recommended corrective actions. The method also logs the validation failure with contextual data for security analysis. The method then terminates, requiring the charging station to retry with valid data if desired. Multiple consecutive validation failures from the same charging station may trigger additional security measures.

If validation succeeds, the method proceeds to step 408, where it queries the denylist database. This query operation is optimized using database indexing and multi-level caching strategies to ensure rapid response times, typically under 50 milliseconds. The query may span multiple database shards or regions depending on the deployment architecture, with automated failover capabilities. The database implements a caching hierarchy including local memory caches, distributed caches, and persistent storage. In some implementations, the query includes fuzzy matching capabilities to catch slight variations in UID representation or detect pattern-based fraud attempts.

In step 410, the method evaluates whether the UID exists in the denylist database. This check considers not only exact matches but also pattern-based rules that might flag ranges of UIDs or specific manufacturing batches. The evaluation includes checking the temporal validity of any denylist entries, as some may have expiration dates or time-based restrictions. The check also considers geographic restrictions that may limit denylist enforcement to specific regions or jurisdictions.

If the UID is denylisted, the method follows the denial path starting at step 412, where it flags the UID as denylisted in the current session context. This flag includes details about which denylist rule was triggered, the original denylisting date, the authority that requested the denylisting, and any associated metadata about the denylisting reason. The flag may also include special handling instructions based on the type of denylisting. In step 414, the method logs the verification event with full context for audit purposes, including all request parameters, matching denylist rules, and timing information.

The method then proceeds to step 416, where it issues notifications to relevant authorities based on the denylisting reason. These notifications may be routed to law enforcement agencies, vehicle manufacturers, or other stakeholders through various channels including REST APIs, message queues, email alerts, or integration with emergency response systems. The notifications include the vehicle's current location, timestamp, charging station details, and historical charging attempts if available. In step 418, the method generates and returns an authorization denied response to the charging station, including any specific handling instructions or user messages.

If the UID is not denylisted, the method checks in step 420 whether additional verification is required. Additional checks may be triggered by factors such as geographic location, time of day, special security protocols, or risk scores calculated from historical charging patterns. These checks provide an extra layer of security for high-risk scenarios or premium charging locations.

If additional verification is needed, the method proceeds to step 422, where it performs supplementary checks. These may include validating the UID against manufacturer databases, checking for recent suspicious activity patterns, verifying regional authorization requirements, conducting real-time risk assessment, or verifying payment pre-authorization. Each check has configurable timeout periods and fallback policies. The results of these checks are evaluated in step 424 using configurable policy rules.

If the additional checks fail, the method logs the failure details in step 426 before proceeding to deny authorization. This logging includes specific check failure information, timing data, and policy evaluation details to support later analysis and policy refinement. The logged data feeds into machine learning models that continuously improve the risk assessment system.

If the additional checks pass, or if no additional checks were required, the method proceeds to step 428. Here, the method generates an authorization token for the charging session. This token includes cryptographic signatures using HSM-backed keys, validity timeframes, maximum power levels, energy limits, and any special monitoring requirements. The token may also include parameters for graduated access or emergency overrides.

The successful authorization is comprehensively logged in step 430 for audit purposes and performance monitoring. The logs include complete request details, processing timestamps, all authorization decisions, and any special conditions applied. These logs feed into analytics systems that track authorization patterns and system performance.

Finally, in step 432, the method returns the authorization granted response to the charging station. This response includes the signed authorization token, session parameters, charging limitations, and any special instructions for the charging session. The charging station can then proceed with power delivery according to the authorization parameters.

Throughout this process, the method implements various optimization techniques such as caching frequently accessed denylist entries, parallel processing of additional checks, and asynchronous notification handling. The method also maintains comprehensive logging for security audit trails while implementing appropriate data retention and privacy protection measures aligned with regional data protection regulations.

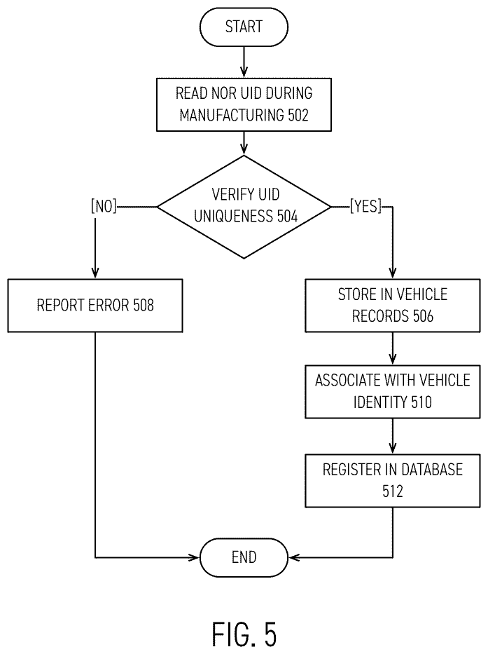

FIG. 5 is a flow diagram illustrating a method for registering and associating a NOR memory UID with a vehicle during the manufacturing process according to some embodiments. This registration process ensures each vehicle has a properly recorded and validated unique identifier before it leaves the manufacturing facility.

In step 502, the method begins by reading the UID from the NOR flash memory device after it has been soldered onto the vehicle's control board. This read operation is performed using automated test equipment (ATE) that interfaces with the board through test points or boundary scan chains. The read operation uses the standard READ ID command supported by the NOR device and retrieves the complete 20-byte device identification data. The test equipment validates that the read operation completes successfully and that all data bits are properly captured.

In step 504, the method verifies the uniqueness of the extracted 14-byte UID portion of the device ID. This verification process queries a manufacturing database that maintains records of all UIDs used in production. The verification ensures not only that the UID has never been used before but also that it follows the expected format based on manufacturing data: correct lot number format, valid wafer coordinates, and plausible timestamp values. The verification may also check that the random portions of the UID maintain sufficient entropy.

If the uniqueness verification fails, the method proceeds to step 508, where it logs a detailed error report. The error report includes: the duplicate or invalid UID, the current vehicle's production information, any conflicting vehicle records, detailed test conditions, and equipment identification data. This error triggers a manufacturing hold condition that requires quality control investigation before the vehicle can proceed in production. The error may also initiate an analysis of the NOR memory programming process to identify any systematic issues.

If the uniqueness verification passes, the method proceeds to step 506, where it stores the validated UID in the vehicle's manufacturing records. These records are maintained in a secure manufacturing execution system (MES) database and include comprehensive production data such as: assembly date, production line identifier, test results, component serial numbers, and quality control checkpoints. The UID becomes part of the vehicle's permanent manufacturing history.

In step 510, the method associates the validated UID with the vehicle's core identity information. This association includes linking the UID with fundamental vehicle data such as: the Vehicle Identification Number (VIN), model information, production configuration, and initial owner data if available. The association process creates cryptographically signed records that bind the UID to the vehicle identity, preventing unauthorized modifications of these associations.

In step 512, the method registers the UID and its associations in a secure database system that will serve as the authoritative source for vehicle authentication. This registration includes creating multiple database records including, without limitation, a primary UID record containing the raw identifier and its validation history, vehicle association records linking the UID to vehicle identifiers, authentication policy records specifying any initial restrictions or special handling requirements, and audit trail records documenting the registration process. In some implementations, the database implements strong consistency models to prevent race conditions during registration and maintains geographically distributed replicas for high availability.

The registration process includes several security features. First, all database transactions are cryptographically signed using hardware security modules (HSMs) to ensure authenticity. Second, the registration creates an immutable audit trail using append-only logs. Third, the system implements access controls that limit which manufacturing systems can create or modify UID registrations.

Throughout the registration process, the method maintains detailed logs of each operation. These logs capture timing information, system states, operator identifications (if manual intervention is required), and cryptographic proofs of each transaction. The logs are essential for quality control, security auditing, and regulatory compliance.

The method supports several manufacturing scenarios. In normal production, the process is fully automated and integrated with the vehicle assembly line's manufacturing execution system. However, the method also supports manual registration procedures for replacement parts or service operations, though these require additional authentication and documentation.

Error handling is particularly robust, as registration failures could impact production line efficiency. The method implements retry mechanisms for transient failures, fallback procedures for system outages, and clear escalation paths for situations requiring human intervention. Each error condition is categorized and tracked to identify systematic issues in the registration process.

This registration method ensures that every vehicle enters service with a properly validated and securely recorded UID, establishing the foundation for the vehicle authentication system. The method's comprehensive approach to validation, association, and registration creates a trustworthy vehicle identity that can be reliably used throughout the vehicle's lifetime for charging authentication and other security-related operations.

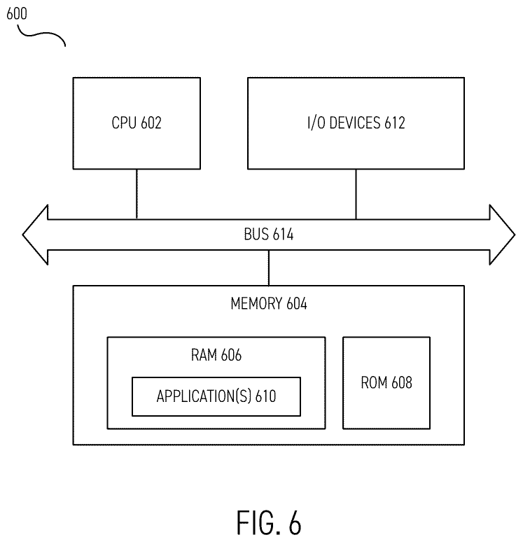

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a charging station, a connection request from an electric vehicle;
requesting, by the charging station, a unique identifier from a NOR flash memory device in the electric vehicle;
receiving, by the charging station, the unique identifier from the electric vehicle;
transmitting, by the charging station, the unique identifier to a cloud service;
receiving, by the charging station, an authorization response from the cloud service based on a verification of the unique identifier against a denylist database; and
selectively enabling or disabling, by the charging station, charging power to the electric vehicle based on the authorization response.

2. The method of claim 1, wherein requesting the unique identifier comprises sending a READ ID command to the NOR flash memory device to retrieve a device identification data structure.

3. The method of claim 2, wherein receiving the unique identifier comprises:
receiving a 20-byte device identification data structure; and
extracting a 14-byte unique identifier from the device identification data structure.

4. The method of claim 1, wherein transmitting the unique identifier comprises:
formatting the unique identifier according to a charging protocol; and
transmitting the unique identifier and contextual data to the cloud service, the contextual data comprising one or more of a charging station identifier and location.

5. The method of claim 1, wherein receiving the authorization response comprises:
receiving a signed authorization token when the unique identifier is not found in the denylist database; and
receiving a denial message and alerting authorities when the unique identifier is found in the denylist database.

6. The method of claim 1, further comprising:
caching, by the charging station, the authorization response for a time period; and
using, by the charging station, the authorization response to authorize charging requests during the time period when a network connection to the cloud service is not available.

7. The method of claim 1, further comprising:
monitoring, by the charging station, power delivery parameters during charging;
periodically, by the charging station, validating the authorization response remains valid; and
terminating, by the charging station, power delivery if the authorization response becomes invalid during charging.

8. A non-transitory computer-readable storage medium for tangibly storing computer program instructions capable of being executed by a computer processor, the computer program instructions defining steps of:
receiving, by a charging station, a connection request from an electric vehicle;
requesting, by the charging station, a unique identifier from a NOR flash memory device in the electric vehicle;
receiving, by the charging station, the unique identifier from the electric vehicle;
transmitting, by the charging station, the unique identifier to a cloud service;
receiving, by the charging station, an authorization response from the cloud service based on a verification of the unique identifier against a denylist database; and
selectively enabling or disabling, by the charging station, charging power to the electric vehicle based on the authorization response.

9. The non-transitory computer-readable storage medium of claim 8, wherein requesting the unique identifier comprises sending a READ ID command to the NOR flash memory device to retrieve a device identification data structure.

10. The non-transitory computer-readable storage medium of claim 8, wherein transmitting the unique identifier comprises:
formatting the unique identifier according to a charging protocol; and
transmitting the unique identifier and contextual data to the cloud service, the contextual data comprising one or more of a charging station identifier and location.

11. The non-transitory computer-readable storage medium of claim 8, wherein receiving the authorization response comprises:
receiving a signed authorization token when the unique identifier is not found in the denylist database; and
receiving a denial message and alerting authorities when the unique identifier is found in the denylist database.

12. The non-transitory computer-readable storage medium of claim 8, the steps further comprising:
caching, by the charging station, the authorization response for a time period; and
using, by the charging station, the authorization response to authorize charging requests during the time period when a network connection to the cloud service is not available.

13. The non-transitory computer-readable storage medium of claim 8, the steps further comprising:
monitoring, by the charging station, power delivery parameters during charging;
periodically, by the charging station, validating the authorization response remains valid; and
terminating, by the charging station, power delivery if the authorization response becomes invalid during charging.

14. A device comprising:
a processor; and
a storage medium for tangibly storing thereon program logic for execution by the processor, the program logic comprising steps for:
receiving a connection request from an electric vehicle;
requesting a unique identifier from a NOR flash memory device in the electric vehicle;
receiving the unique identifier from the electric vehicle;
transmitting the unique identifier to a cloud service;
receiving an authorization response from the cloud service based on a verification of the unique identifier against a denylist database; and
selectively enabling or disabling charging power to the electric vehicle based on the authorization response.

15. The device of claim 14, wherein requesting the unique identifier comprises sending a READ ID command to the NOR flash memory device to retrieve a device identification data structure.

16. The device of claim 15, wherein receiving the unique identifier comprises:
receiving a 20-byte device identification data structure; and
extracting a 14-byte unique identifier from the device identification data structure.

17. The device of claim 14, wherein transmitting the unique identifier comprises:
formatting the unique identifier according to a charging protocol; and
transmitting the unique identifier and contextual data to the cloud service, the contextual data comprising one or more of a charging station identifier and location.

18. The device of claim 14, wherein receiving the authorization response comprises:
receiving a signed authorization token when the unique identifier is not found in the denylist database; and
receiving a denial message and alerting authorities when the unique identifier is found in the denylist database.

19. The device of claim 14, the steps further comprising:
caching the authorization response for a time period; and
using the authorization response to authorize charging requests during the time period when a network connection to the cloud service is not available.

20. The device of claim 14, the steps further comprising:
monitoring power delivery parameters during charging;
periodically validating the authorization response remains valid; and
terminating power delivery if the authorization response becomes invalid during charging.
